(19) United States
(12) Patent Application Publication
(10) Pub. No.: US 2010/0084932 A1
(43) Pub. Date: Apr. 8, 2010

(54) Cooling Fan having Oil-impregnated Bearing

(75) Inventor: Hong-Guang Li, Sinjhuang City (TW)

Correspondence Address: NIKOLAI & MERSEREAU, P.A., 900 SECOND AVENUE SOUTH, SUITE 820, MINNEAPOLIS, MN, 55402, US

(73) Assignee: ASIA VITAL COMPONENTS CO., LTD., Sinjhuang City (TW)

(21) Appl. No.: 12/246,874

(22) Filed: Oct. 7, 2008

(51) Int. Cl. H02K 5/16

(52) U.S. Cl. 310/89

(57) ABSTRACT

A cooling fan with oil-impregnated bearing includes a bearing seat having a bearing housing; a bearing rightly fitted in the bearing housing with a colloidal material applied between them to maintain dimensional precision of the bearing and the bearing housing; and a fan hub mounted on and around the bearing housing with a rotary shaft extended through the bearing. The bearing housing has a distal end integrally formed into a retaining section to prevent leakage of lubricating oil, and a proximal end having a bottom cap tightly fitted therein with a colloidal material applied between the bearing housing and the bottom cap. The bearing is formed at positions near the retaining section and the bottom cap with an oil receiving space each to minimize loss of lubricating oil. A supporting plate is provided in the bottom cap to support the rotary shaft, allowing the fan hub to rotate stably.

### FIELD OF THE INVENTION

The present invention relates to a cooling fan having oil-impregnated bearing, and more particularly to a cooling fan that maintains good component dimensional precision and operates at reduced friction to have prolonged usable life.

### BACKGROUND OF THE INVENTION

Recently, various electronic information products, such as computers, have become highly popular among consumers and are widely applied to various fields. The demands for electronic information products lead, to rapid development in electronic information techniques. It is a trend to develop electronic information products with increased operating speed and expanded access capacity. When operating at high speed, the components of the electronic information products would also produce a large amount of heat.

For example, among others, the central processing unit (CPU) of a computer produces the largest part of heat in the computer. The CPU would become slow in running when the heat produced and accumulated in the computer gradually increases. When the heat accumulated in the computer exceeds an allowable limit, the computer is subject to the danger of shutdown or even becoming seriously damaged. Moreover, to solve the problem of electromagnetic radiation, a case is used to enclose all the important computer components and elements therein. Therefore, it is very important to quickly dissipate the heat produced by the CPU and other heat-producing elements in the computer case.

Conventionally, a heat sink and a cooling fan are mounted atop the CPU to help in dissipating the heat produced by the CPU. A first side of the heat sink is formed of a plurality of radiating fins, while an opposite second side of the heat sink without radiating fin is in direct contact with the CPU to conduct the heat produced by the CPU to the radiating fins, from where the heat is radiated into ambient air. Meanwhile, the cooling fan produces airflows to carry away the hot air surrounding the CPU and the heat sink, enabling quick dissipation of heat from the CPU.

Please refer to FIG. 1, which is an assembled sectional view of a conventional cooling fan 1. As shown, the cooling fan 1 includes a main body 10 having a centered locating seat 12 formed on an inner side thereof. The locating seat 12 has a hollow bearing housing 121 protruded therefrom. A bearing 13 is mounted in the bearing housing 121 and a tan hub 14 is rotatably mounted on and around the bearing housing 121. The fan hub 14 has a plurality of blades 141 spaced along an cuter circumferential surface of the fan hub 14. A rotary shaft 142 is provided on an inner side of the fan hub 14 to rearward extend through the bearing 13 and is held in place by a retainer ring 143 and an oil ring 144.

The above-described cooling fan has some disadvantages in practical use thereof. For example, when the rotary shaft 142 is assembled to the bearing 13, an amount of lubricating oil is applied to a rear end of the bearing 13. When the cooling fan 1 operates, the lubricating oil is released from sintered pores of the bearing 13 to lubricate the rotary shaft 142 rotating at high speed and thereby avoid dry friction between the rotary shaft 142 and the bearing 13 and damage from such dry friction. However, the oil ring 144 mounted on the rotary shaft 142 is not able to prevent the lubricating oil from leaking out through a front open end of the bearing housing 121. Moreover, the rotary shaft 142 is held in place by the retainer ring 143, and the bearing 13 is pushed into the bearing housing 121 to associate with the bearing housing 121 in a tight-fit relation, so that an increased tightness between the bearing 13 and the bearing housing 121 can be obtained. When pushing the bearing 13 into the bearing housing 121, stress is concentrated at an end face of the bearing 13 to adversely affect the effective porosity of the bearing 13. As a result, noise will be produced while the cooling fan 1 operates and the usable life of the cooling fan 1 will be shortened.

Therefore, the above-described conventional cooling fan 1 could not satisfy users due to the following disadvantages: (1) The effective porosity of the bearing is adversely affected; (2) The lubricating oil is likely to leak out; (3) The balance between the fan hub and the locating seat is poor; and (4) Noises are produced when the cooling fan operates and the usable life of the cooling fan is shortened.

### SUMMARY OR THE INVENTION

A primary object of the present invention is to provide a cooling fan having oil-impregnated bearing, a bearing of which can maintain good effective porosity without being adversely affected when the bearing is assembled to a bearing housing of the cooling fan in a tight-fit relation. Therefore, it is ensured the bearing can maintain precise tolerance to prolong the usable life of the cooling fan.

Another object of the present invention is to provide a cooling fan having oil-impregnated bear, a bearing of which is effectively held in place in a bearing housing by providing a bottom cap fitted in the bearing housing in a tight-fit relation and applying a colloidal material between the bearing housing and the bottom cap.

A further object of the present invention is to provide a cooling fan having oil-impregnated bear, a bear of which is formed on front and rear portions with an oil receiving space each to minimizing loss of lubricating oil.

To achieve the above and other objects, the cooling fan having oil-impregnated bearing according to the present invention includes a bearing seat, a bearing, and a fan hub. The bearing seat has a forward extended bearing housing centered thereon for receiving the bearing therein. The bearing housing is integrally formed near a distal end with a radially inward extended retaining section and has a bottom cap tightly fitted in a proximal end thereof with a colloidal material applied between an outer circumferential surface of the bottom cap and an inner circumferential surface of the bearing housing. The bearing is mounted in the bearing housing and held in place between the retaining section and the bottom cap, and is associated with the bearing housing in a tight-fit relation with a colloidal material applied between the bearing housing and the bearing. The bearing is provided at positions near the retaining section and the bottom cap with an oil receiving space each. The fan hub is mounted on and around the bearing housing, and has a rotary shaft rearward extended through the bearing. The rotary shaft has a free end adjacent to the bottom cap and having a spherical end face. A supporting plate is provided in the bottom cap to support the spherical end face of the rotary shaft thereon, enabling the fan hub to stably operate. The bearing is located in the bearing housing between the retaining section and the bottom rap without the risk of losing the dimensional precision thereof. Meanwhile, friction between the rotary shaft, the bearing, and the bearing housing is minimized to enable prolonged service life of the cooling fan.

With the above arrangements, the cooling fan having oil-impregnated bear according to the present invention has the following advantages: (1) The bearing can keep its effective porosity; (2) The bearing can be effectively held in place; (3) The fan hub can more stably operate; (4) Loss of lubricating oil is effectively minimized; and (5) Friction between the bearing and the bearing housing is minimized to prolong the usable life of the cooling fan.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an assembled sectional view of a conventional cooling fan;

FIG. 2 is an exploded sectional view of a cooling fan according to a preferred embodiment of the present invention;

FIG. 3 is an assembled view of FIG. 2;

FIG. 3A is an enlarged view of the circled area 3A of FIG. 3; and

FIG. 3B is an enlarged view of the circled area 3B of FIG. 3.

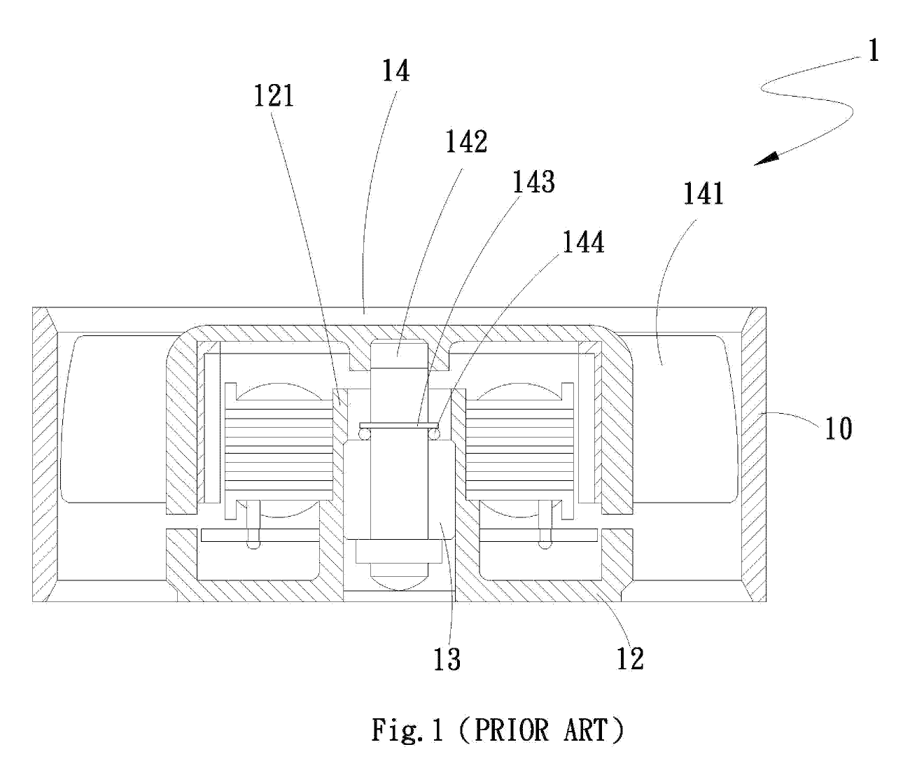

### DETAILED DESCRIPTION OF THE PREFERRED EMBODIMENTS

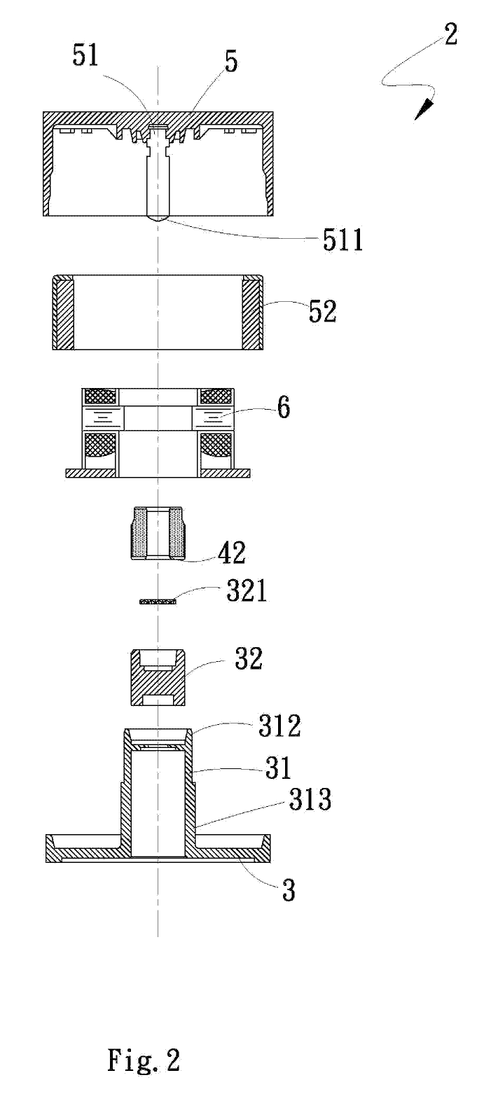

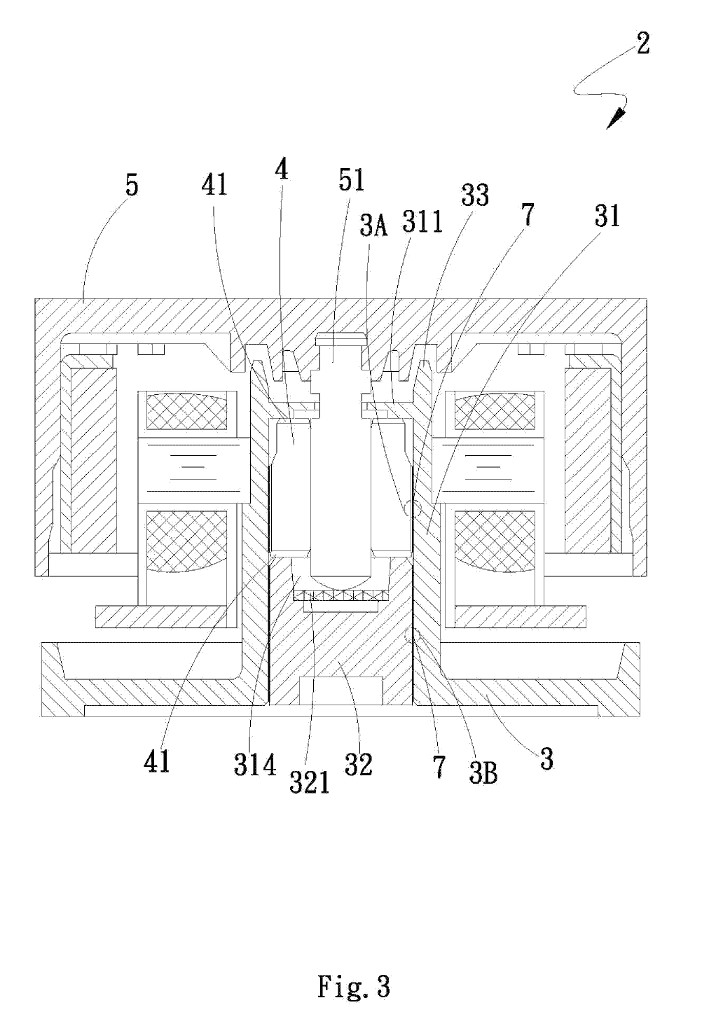

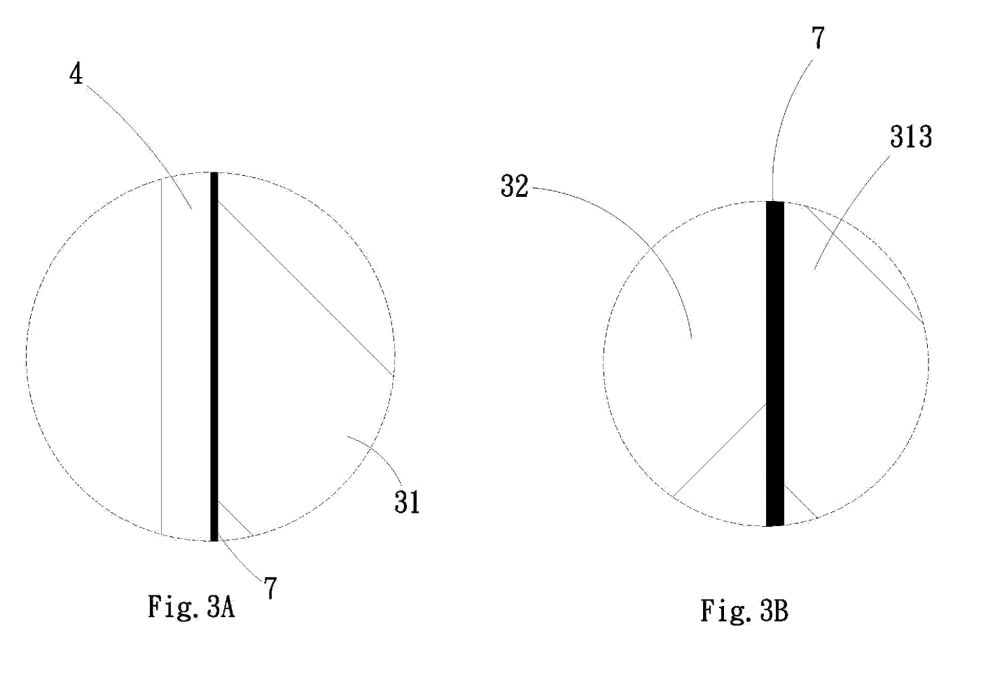

Please refer to FIGS. 2 and 3, in which a cooling fan with oil-impregnated bearing according to a preferred embodiment of the present invention is shown. As shown, the cooling fan of the present invention as generally denoted by reference numeral 2 includes a bearing seat 3, a bearing 4, and a fan hub 5.

The bearing seat 3 can be mounted in a fan frame or on a heat sink. The bearing seat 3 has a forward extended bearing housing 31 centered thereon for receiving the bearing 4 therein. The bearing housing 31 has a first or distal end 312 and a second or proximal end 313. The first end 312 of the bearing housing 31 defines an opening communicating with an interior of the bearing housing 31. The second end 313 of the bearing housing 31 is connected to the bearing seat 3. A retaining section 311 is integrally formed near the first end 312 of the bearing housing 31 to radially inward extend from an inner wall surface of the bearing housing 31.

The bearing 4 is associated with the bearing housing 31 in a tight-fit relation to effectively increase the tightness between the bearing 4 and the bearing housing 31. A bottom cap 32 is fitted in the second end 313 of the bearing housing 31 in a tight-fit relation, so that the bearing 4 is effectively held in place in the bearing housing 31 between the retaining section 311 and the bottom cap 32.

The fan hub 5 is mounted on and around the bearing housing 31. The fan hub 5 has a rearward extended central rotary shaft 51 extended through the bearing 4 into the bottom cap 32. The rotary shaft 51 is provided at a free end with a spherical end face 511. A supporting plate 321 is provided in the bottom cap 32 corresponding to the rotary shaft 51, so that the fan hub 5 is rotatably mounted on the bearing seat 3 with the spherical end face 511 of the rotary shaft 51 abutting against the supporting plate 321.

The second end 313 of the bearing housing 31 defines an oil receptacle 314 therein. The bearing 4 is formed at front and rear portions adjacent to the retaining section 311 and the bottom cap 32, respectively, with an oil receiving space 41 each. In the illustrated preferred embodiment, the second end 313 of the bearing housing 31 is sealed by the bottom cap 32. However, it is understood the second 313 can be otherwise an open end (not shown).

A coil assembly 6 is externally mounted around the bearing housing 31 to associate with the bearing housing 31 in a tight-fit relation. A magnetic ring 52 is mounted to an inner circumferential surface of the fan hub 5 to space from and locate around the coil assembly 6, so that the magnetic ring 52 can magnetically interact with the coil assembly 6 to thereby drive the fan hub 5 and the rotary shaft 51 to rotate relative to the bearing seat 3 to achieve the purpose of dissipating heat.

FIGS. 3A and 3B are enlarged views of the circled areas 3A and 3B of FIG. 3, respectively. Please now refer to FIG. 3 along with FIGS. 3A and 3B. According to FIG. 3, the bearing housing 31 is perpendicularly extended from and centered on the bearing seat 3. The bearing 4 is located in and associated with the bearing housing 31 in a tight-fit relation. A colloidal material 7 is applied to an inner circumferential surface of the bearing housing 31 and an outer circumferential surface of the bearing 4. When the bearing 4 is tightly fitted in the bearing housing 31, the colloidal material 7 protects the bearing 4 against undesired detriment to the effective porosity of the bearing 4 and maintains the bearing 4 at required dimensional tolerance and precision. The retaining section 311 is located in front of the bearing 4, while the bottom cap 32 is located behind the bearing 4. A colloidal material 7 is applied to the inner circumferential surface of the bearing housing 31 and an outer circumferential surface of the bottom cap 32. The oil receiving spaces 41 provided on the bearing 4 near the retaining section 311 and the bottom cap 32 can minimize the loss of lubricating oil. The rotary shaft 51 of the fan hub 5 is extended through a central chaff hole 42 of the bearing 4 with the spherical end face 511 of the rotary shaft 51 abutted against the supporting plate 321, so that the rotary shaft 51 is supported on the supporting plate 321, enabling the fan hub 5 to stably operate. In addition, the bearing housing 31 is provided with a protective section 33, which is located between the fan hub 5 and the first end 312 of the bearing housing 31 to prevent dust from entering the bearing housing 31 and prevent the lubricating oil from spilling out of the bearing housing 31. A clearance between the fan hub 5 and the bearing 4 can be determined by a thickness possibly produced by the lubricating oil, so that the fan hub 5 can rotate at increased balance. Moreover, since the bearing housing 31 and the bearing 4 are maintained at high dimensional precision, the friction between them can be minimized when the cooling fan 2 operates in a normal state. Therefore, the cooling fan 2 can have prolonged service life.

The present invention has been described with a preferred embodiment thereof and it is understood that many changes and modifications in the described embodiment can be carried out without departing from the scope and the spirit of the invention that is intended to be limited only by the appended claims.

1. A cooling fan, comprising:
a bearing seat having a bearing housing forward extended therefrom, the bearing housing being integrally formed near a distal end with a radially inward extended retaining section and having a bottom cap tightly fitted in a proximal end thereof, and a colloidal material being applied between an outer circumferential surface of the bottom cap and an inner circumferential surface of the bearing housing;
an oil impregnated bearing being mounted in the bearing housing with a colloidal material applied between the bearing and the inner circumferential surface of the bearing housing; and
a fan hub being mounted on and around the bearing housing, the fan hub being provided on an inner side with a rearward extended rotary shaft, and the rotary shaft being extended through the bearing and engaging a supporting plate held by the bottom cap.

2. The cooling fan as claimed in claim 1, wherein the bottom cap is pushed into the bearing housing to associate with the bearing seat in a tight-fit relation, so that an increased tightness between the bearing seat and the bottom cap is obtained.

3. The cooling fan having oil-impregnated bearing as claimed in claim 1, wherein the bearing is formed at a front portion with an oil receiving space.

4. The cooling fan as claimed in claim 1, wherein the bearing is formed at a rear portion with an oil receiving space.

5. The cooling fan as claimed in claim 1, wherein the rotary shaft is provided at a free end adjacent to the bottom cap with a spherical end face, and the supporting plate engaging the spherical end face of the rotary shaft.

6. The cooling fan as claimed in claim 1, wherein the bearing is pushed into and associated with the bearing housing in a tight-fit relation, so that an increased tightness between the bearing and the bearing housing is obtained.

7. The cooling fan as claimed in claim 3, wherein the bearing housing is provided with a protective section, which is located between the fan hub and the distal end of the bearing housing, said protective section isolating the oil receiving space from ambient dust.
